(19) United States
(12) Patent Application Publication
(10) Pub. No.: US 2006/0161391 A1
(43) Pub. Date: Jul. 20, 2006

(54) Knowledge-forming apparatus and parameter-retrieving method as well as program product

(75) Inventors: Hironori Inaba, Soraku-gun (JP); Kazuto Kojitani, Osaka (JP); Yuji Hirayama, Kashihara-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/248,025

(22) Filed: Oct. 11, 2005

(30) Foreign Application Priority Data
Oct. 8, 2004 (JP) 2004-297034

(51) Int. Cl. G21C 17/00; G06F 11/30

(52) U.S. Cl. 702/183

(57) ABSTRACT

A device that is capable of easily determining discrimination knowledge suitable for recognizing a normal/abnormal state of an object to be inspected in an inspecting and diagnosing apparatus is provided with: a parameter-retrieving unit that retrieves various parameter sets used for calculating feature amounts, a feature-amount operation unit that calculates a plurality of feature amounts based upon the respective parameter sets that have been retrieved by the retrieving unit in association with learning data that includes given normal data and abnormal data, a primary evaluation unit that outputs the effectiveness of each of the parameter sets as evaluated values based upon the results of the operation of the feature amounts calculated by the feature-amount operation unit, an optimal solution candidate output unit that, based upon the results of the primary evaluation found by the primary evaluation unit, outputs the results of a plurality of parameter sets having a high primary evaluated value as a plurality of optimal solution candidates, a discrimination knowledge forming unit that forms a plurality of discrimination knowledge based upon the optimal solution candidates output from the optimal solution candidate output unit, a secondary evaluation unit that evaluates on each of the discrimination knowledge that have been formed in the discrimination knowledge forming unit and an optimal solution output unit that, based upon the results of the secondary evaluation, outputs the discrimination knowledge having a high evaluated value as an optimal solution.

### BACKGROUND OF THE INVENTION

1. Field of the Invention

The present invention relates to a knowledge-forming apparatus and a parameter-retrieving method, and also concerns such a program product.

2. Description of the Related Art

A large number of rotary devices in which motors are installed have been used in automobiles, electric appliances and the like. For example, automobiles are provided with rotary devices in various parts such as an engine, a power steering, power sheets and a transmission. Moreover, with respect to the electric appliances, various products such as refrigerators, air conditioners and washing machines are provided with such rotary devices. Here, when each of these rotary devices is operated, sounds are generated due to rotations of the motor and the like.

Some sounds are inevitably generated following normal operations, and other sounds are caused due to defective operations. Some examples of defective operations causing abnormal sounds include: abnormal bearings, internal abnormal contacts, unbalanced operations and intrusion of foreign matters. More specifically, abnormal sounds are caused by a chipped gear that generates noise at a frequency of once per gear rotation, a meshed foreign matter and a spot scratch as well as a rubbing sound caused by a rotary portion and a fixed portion inside a motor that touch with each other for a moment during rotation. Moreover, the noises uncomfortable to human ears are various in the audible range of 20 Hz to 20 kHz, and have the frequency of about 15 kHz, for example. An abnormal noise is generated in the case where the sound of this predetermined frequency component is involved. Of course, the abnormal sounds are not limited by this frequency.

These noises due to malfunctions are not only uncomfortable but also may cause a more serious malfunction. Therefore, in order to ensure quality for respective products, production factories normally carry out “sensory inspections” that depend on five senses, such as auditory sense and tactile sense, by inspectors so as to determine the presence or absence of abnormal sounds. More specifically, those inspections are conducted by hearing sounds by the ear and confirming vibrations by the hand. Here, the sensory inspections are defined by JIS Z8144 in its sensory inspection terms.

In recent years, there have been strong demands for strict noise-preventive quality for automobiles. In other words, in the automobile industry, there have been strong demands for automatically inspecting vehicle-use driving parts, such as engines, transmissions and power sheets, quantitatively, and conventional qualitative, obscure inspections, such as the above-mentioned sensory inspections, conducted by inspectors have failed to satisfy the demands and produce the corresponding quality.

In order to solve the problems, an abnormal sound inspecting system, which achieves a stable inspection based upon a quantitative, clear standard, has been developed. In this abnormal sound inspecting system, “sensory test” processes are automated, and vibrations and sounds, generated in driving sections of a product, are measured by sensors so that the resulting analog signal and its frequency components are examined by using a frequency analyzing device using an FFT algorithm and the like. In addition, the analysis of the analog signal may be conducted by using band-pass filters.

The following description will briefly discuss this technique. In a frequency-analyzing device using the FFT algorithm, the frequency range of a time-domain signal can be analyzed by using a high-speed Fourier conversion algorithm. Here, a frequency range of abnormal sounds is fixed at a certain level. Therefore, since among frequency components extracted by the analysis, components corresponding to the generation range of abnormal sounds can be extracted, the feature amount of such extracted components is found. Then, the presence or absence of abnormality and the cause thereof are estimated from the feature amount by using a fuzzy inference or the like.

In the above-mentioned abnormal sound inspecting system, an automatic determining process in accordance with a predetermined standard is carried out, and the results of the inspection and the corresponding waveform data can be stored in a storage device inside the abnormal sound inspecting system.

At present, in an abnormal sound inspecting system, selection of optimal feature amount and selection of the respective parameter sets used for feature-amount calculations are conducted based upon human senses and experiences. Conventionally, in an attempt to automate such a system for retrieving optimal parameter sets, for example, “an optimization processing method and a device using a genetic algorithm” has been proposed. A hierarchical genetic algorithm and a parallel genetic algorithm, used in this method and device, are considered to devote to improvements in retrieving precision given the complex optimizing system in the genetic algorithm.

In the conventional abnormal sound inspecting system, a process for extracting feature amounts corresponding to the presence or absence of abnormality and a process for selecting respective parameter sets used for calculating the feature amounts are conducted based upon the intuition and experiences of the person.

Therefore, selecting feature amounts corresponding to the presence or absence of abnormality and parameter sets that are used for calculating the feature amounts from several thousand or more results requires not only the intuition and experiences, but also a large number of processes, resulting in a failure in automating the inspecting/diagnosing procedures.

In particular, for example, in the automobile industry, the number of new vehicle sales usually peak immediately after release and tend to drop off after several months; therefore a high product conformity rate is required from the start of the production of a new model, with strong demands for immediately improving the product quality. For this reason, optimal parameter sets for an abnormal sound inspecting system need to be determined as early as possible; however, when the determination of optimal parameters is made based upon the intuition and experiences of human, this process is somewhat delayed.

Moreover, in an attempt to apply a hierarchical genetic algorithm to an arrangement for specifying optimal parameters used for an abnormal sound inspecting system, poses the following problems. Specifically, the parameters for controlling the operation of the generic algorithm (crossover value, mutation rate, selection method) having no hierarchical structure are set by trial and error. In the case where such parameters are accumulated in the hierarchy, trial and error becomes equivalent to manual selection of the feature amount and the operation parameters required to acquire the desired result.

Moreover, since the process for controlling the genetic algorithm itself becomes complex, it becomes difficult to incorporate a retrieving strategy that is suitable for the characteristics (influences exerted among the parameters) of respective parameters to be retrieved. Consequently, even if the above-mentioned method is used, it becomes difficult to find optimal parameters effectively with a short period of time.

Furthermore, data relating to the presence or absence of abnormality (teaching data used for learning, i.e. sample data), determined by the operator may contain some errors. An attempt to retrieve parameters with erroneous sample data may fail, or require a large amount of time before an optimal solution is reached.

Moreover, in the case where one or more pieces of knowledge are created by using feature amounts with operational parameter sets, as in the case of a sensory inspection (abnormal sound inspection), a certain single parameter may influence a plurality of feature amounts. For example, in the case where feature amounts are calculated from waveform data, as in the case of abnormal sound inspection, first, an inputted waveform is subjected to a filtering process by a band-pass filter so that unnecessary components are removed, and then, respective feature amounts are calculated by using respective parameter sets. In this case, the parameter relating to the filter is a commonly used parameter with respect to a plurality of feature amounts, by applying the filter for easily distinguishing good articles and defective articles with a certain feature amount, the differences between good articles and defective articles tends to be hardly distinguishing with the other feature amounts. Therefore, it is not possible to determine a parameter by simply paying attention to only one feature amount.

### SUMMARY OF THE INVENTION

The object of the present invention is to provide a knowledge-forming apparatus which makes it possible to provide effective feature amounts that is suitably used for determining a normal/abnormal state of an object to be inspected in an inspecting and diagnosing apparatus, to easily determine respective parameter sets used for calculating the effective feature amounts and to easily find the effective feature amounts with high precision and short period of time, even when sample data used for retrieving contains ambiguity, as well as a parameter retrieving method and a program product relating to such an apparatus.

A knowledge forming apparatus in accordance with the present invention, which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising: a retrieving unit that retrieves a plurality of parameter sets used for calculating feature amounts; a feature-amount operation unit that calculates a plurality of feature amounts based upon the respective parameter sets that have been retrieved by the retrieving unit, in association with learning data containing given normal data and abnormal data; a primary evaluation unit that outputs the effectiveness of respective parameter sets as an evaluated value based upon the results of the operation of the feature amounts calculated by the feature-amount operation unit; an optimal solution candidate output unit that, based upon the results of the primary evaluation found by the primary evaluation unit, outputs the plurality of parameter sets having a high primary evaluated value as a plurality of optimal solution candidates; a discrimination knowledge forming unit that forms a plurality of discrimination knowledge based upon the optimal solution candidates output from the optimal solution candidate output unit; a secondary evaluation unit that evaluates respective discrimination knowledge that have been formed in the discrimination knowledge forming unit; and an optimal solution output unit that, based upon the results of the secondary evaluation, outputs the discrimination knowledge having a high evaluated value as an optimal solution.

The retrieving unit is preferably designed to again retrieve the respective parameter sets based upon the results of evaluation in the primary evaluation unit so that effective feature amount having a high evaluated value and the respective parameter sets of the effective feature amount are simultaneously determined.

With respect to a group of feature amounts that share the same parameter sets, the primary evaluation unit is preferably designed to output a weighted sum with weights as a primary evaluated value by using weights that are set in the respective feature amounts. On the assumption of installation of this function, the primary evaluation unit is preferably allowed to calculate a plurality of primary evaluated values with respect to one of the respective parameter sets, by using a plurality of patterns of weights that are set for each of the feature amounts. Moreover, the primary evaluation unit is also preferably allowed to calculate a plurality of primary evaluated values with respect to one of the parameter sets by using a plurality of kinds of evaluation expressions. The primary evaluation unit preferably has a function for calculating a primary evaluated value for each of the feature amounts.

A discrimination knowledge forming method in accordance with the present invention, which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising the steps of: calculating a plurality of feature amounts based upon the respective parameter sets that have been set, in association with learning data containing given normal data and abnormal data; calculating a primary evaluated value indicating the effectiveness of each of the parameter sets based upon the results of the operation of the feature amounts calculated by the feature-amount operation unit; based upon the primary evaluated value, again retrieving the respective parameter sets to repeatedly execute calculations of the feature amounts and calculations of the evaluated values based upon the respective parameter sets that have been retrieved; based upon the primary evaluated values upon satisfying retrieving completion conditions that have been set, determining a plurality of parameter sets as a plurality of optimal solution candidates, based upon the optimal solution candidates, forming a plurality of discrimination knowledge; and executing a secondary evaluation for each of the discrimination knowledge, based upon the results of the secondary evaluation, the discrimination knowledge having a high evaluated value is determined as an optimal solution.

In the case when the results of the secondary evaluation have failed to satisfy completion conditions, the process is again executed from the step of calculating the feature amount. Moreover, in the case when the results of the secondary evaluation have failed to satisfy completion conditions, upon again executing the process from the step of calculating the feature amount, the respective parameter sets, which have been used upon forming discrimination knowledge having a high secondary evaluations, are utilized as the respective parameter sets to be given to the feature-amount operation unit.

A program product in accordance with the present invention, which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising a program portion for executing the processes of: allowing a feature-amount operation unit to calculate a plurality of feature amounts based upon the respective parameter sets that have been set, in association with learning data containing given normal data and abnormal data; calculating primary evaluated values indicating effectiveness of each of the parameter sets based upon the results of the operation of the feature amounts calculated by the feature-amount operation unit; based upon the primary evaluated value, again retrieving the parameter sets to repeatedly execute calculations of the feature amounts and calculations of the primary evaluated values based upon the respective parameter sets; based upon the primary evaluated values upon satisfying retrieving completion conditions that have been set, determining a plurality of parameter sets as a plurality of optimal solution candidates so that the plurality of discrimination knowledge are formed based upon the optimal solution candidates; executing a secondary evaluation on each of the discrimination knowledges; and based upon the results of the secondary evaluation, the discrimination knowledge having a high evaluated value is determined as an optimal solution.

In accordance with the present invention, a primary evaluation is carried out, and a plurality of parameter sets having high primary evaluated values (which easily allows determination as to OK or NG by paying attention to the feature amount) are selected and these are prepared as optimal solution candidates. Next, these optimal solution candidates are evaluated in detail, that is, a plurality of discrimination knowledge are actually created based upon the respective optimal solution candidates, and the respective discrimination knowledge are evaluated (secondary-evaluated) so that truly optimal discrimination knowledge can be created at high speeds.

Moreover, in the present invention, it is not necessary to limit the final discrimination knowledge to only one. In other words, by creating a plurality of discrimination knowledge for a plurality of optimal solution candidates, a plurality of discrimination knowledge can be used differently on demand, while referring to secondary evaluations of the respective knowledge. In the case when a retrieval area specifying unit is prepared, by preliminarily excluding unnecessary feature amounts from the calculation subject by using the specifying unit, it becomes possible to create the knowledge more quickly.

Respective feature amount is an item that is indicating a state quantitatively, and discrimination knowledge, such as fuzzy knowledge, is described by using the feature amounts. When the value of the feature amounts is changed, the resulting discrimination knowledge is also changed. Respective parameter set is a set of items required for calculating the feature amount. The feature amount is indicated by using the parameter sets. When the results of parameter adjustments are changed, the value of the feature amount is also changed.

In the embodiment, the “inspecting and diagnosing apparatus” is prepared as a abnormal sound inspecting system (device); however, the present invention is not intended to be limited by this, and may be applied to another inspecting and diagnosing apparatus for vibration and other waveform signals. Moreover, regardless of the waveform signals, the apparatus can be applied to various other facility-maintenance and inspecting apparatuses so that parameter sets and the like for the measuring methods related to those apparatuses can be determined.

By using the present invention, it becomes possible to easily determine discrimination knowledge suitable for determining a normal/abnornal state of an object to be inspected in an inspecting and diagnosing apparatus.

### BRIEF DESCRIPTION OF THE DRAWINGS

FIG. 1 shows a block diagram that indicates a first embodiment of the present invention.

FIG. 2 shows a drawing that explains a data structure of an inspection management file.

FIG. 3 shows a flow chart that explains a function (operational principle) of the first embodiment.

FIG. 4 shows a drawing that indicates one example of coding.

FIG. 5 shows one example of a table index that indicates values of respective genes in the coding.

FIG. 6 shows another example of a table index that indicates values of respective genes in the coding.

FIG. 7A shows a drawing that explains a cross. FIG. 7B shows a drawing that explains a mutation.

FIG. 8 shows a drawing that indicates one example of a data structure of output data that an optimal solution output unit releases.

FIG. 9 shows a drawing that indicates one example of a data structure output from the optimal solution output unit.

FIG. 10 shows a block diagram that indicates a second embodiment of the present invention.

FIG. 11 shows one example of a data structure that specifies a pinpointing process of a retrieving range specified by a retrieving range specifying unit 18.

FIG. 12 shows a flow chart that explains a function (operational principle) of the second embodiment.

FIG. 13 shows a block diagram that indicates a third embodiment of the present invention.

FIG. 14 shows a flow chart that explains a function (operational principle) of the third embodiment.

FIG. 15A and FIG. 15B show a drawing that indicates one example of operation results obtained by using parameter sets in an example in accordance the first embodiment.

FIG. 16A and FIG. 16B show a drawing that indicates one example of a parameter retrieving process in the example.

FIG. 17A and FIG. 17B show a drawing that indicates one example of values of feature amount that are obtained through a primary evaluation in the example.

FIG. 18A and FIG. 18B show a drawing that explains a discrimination evaluation in the example.

FIG. 19 shows a drawing that explains that good articles are not sufficiently separated from defective articles by the use of only one feature amount.

FIG. 20 shows a drawing that explains that good articles are separated from defective articles with high precision by using a plurality of feature amounts.

### DESCRIPTION OF THE PREFERRED EMBODIMENTS

Prior to explaining respective embodiments, first, the following description briefly discuss a abnormal sound inspecting system (waveform inspecting system) that is an object in which feature amounts and parameter sets are set through the present embodiments, and the present system has a basic structure in which: after waveform data acquired through a vibration sensor, a voice microphone or the like has been subjected to a preprocess by using a filter, a plurality of predetermined feature amounts are extracted, and by using effective ones of the feature amounts thus extracted, a general feature amount is found, and based upon the resulting value, determination is made on good articles/detective articles/indefinite articles. With respect to the filter, several kinds of filters, such as bandpass filters, low-pass filters and high-pass filters, are prepared, and a many types of feature amounts (for example, 40 types) to be extracted are prepared. Preprocesses, feature amounts and the like, which are effectively used for making an OK/NG determination, are preliminarily determined. Consequently, when feature amounts that are not so effective have been preliminarily known, processes for finding such feature amounts that are not so effective are wasteful. In the present invention, feature amounts and the like that are suitable for an object to be inspected are found, and applied to an abnormal sound inspecting system. Here, with respect to each of the feature amounts, although its operation method has been determined, the resulting value of the feature amount and consequently the results of determination vary when the parameter sets are changed. In other words, when parameter sets are erroneously set, even an originally effective feature amounts or the like tends to cause an erroneous determination.

Conventionally, based upon sample data, a man carries out simple analyses on an object while making tries and errors, and finds some feature amounts that is likely to be effectively applied to OK/NG determination for the object. Then, based upon thousands of sample data (including results of determination as to good articles/defective articles), a man makes tries and errors to determine as to which filters are finally used as a preprocess, as to what the value of the parameters are used for the filter, as to which amounts of features is used and as to what the value of the parameters for the feature amounts are used so that the man determines effective setting conditions. Thus, since effective feature amounts and the like are obtained, an OKING determination can be effectively made in a short time by setting only the effective feature amounts, parameter sets and the like, in an actual abnormal sound inspecting system.

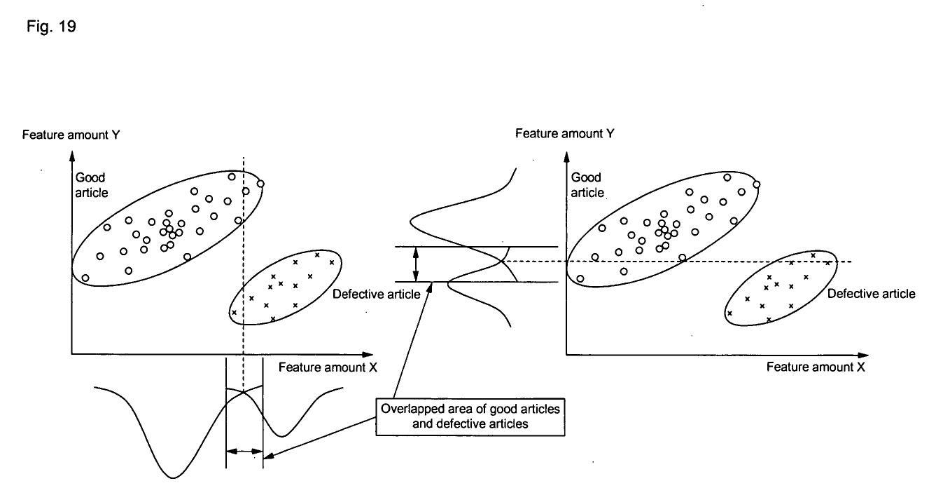

The reason for carrying out a discriminating process by using a plurality of feature amounts is explained as follows: As shown in FIG. 19, there are deviations in data between good articles and defective articles. Therefore, even when attention is given only to a single feature amount, an overlapped area is caused with the result that the defective articles are not excluded. In other words, the separation is not executed by using only the feature amount X, or it is not executed by using only the feature amount Y.

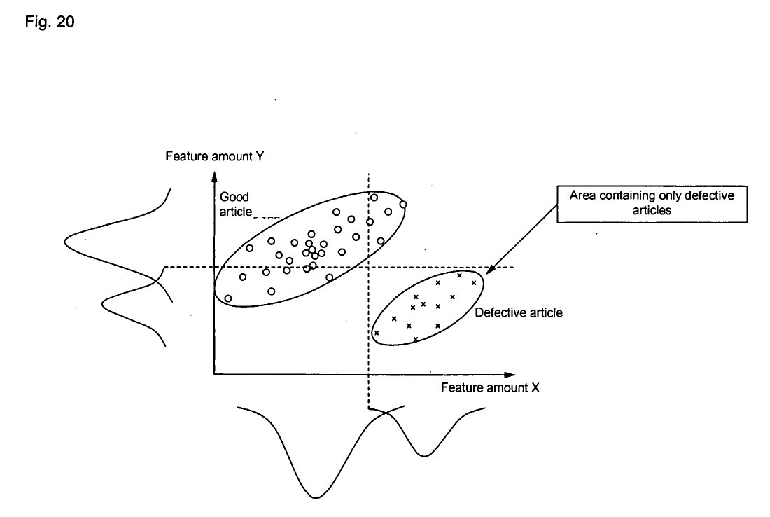

In contrast, as shown in FIG. 20, when attention is given to a plurality of feature amounts, it becomes possible to eliminate the overlapped area between the good articles and the defective articles. In other words, this example makes it possible to completely separate only the defective articles by combining the feature amounts X and Y. By combining a plurality of feature amounts, it becomes possible to carry out a determining process efficiently with high performances. Of course, a border (parameter) used for discriminating good articles from defective articles in the respective feature amounts needs to be set accurately, and when this setting is not appropriate, it is not possible to effectively carry out a determining process even when a plurality of feature amounts are used.

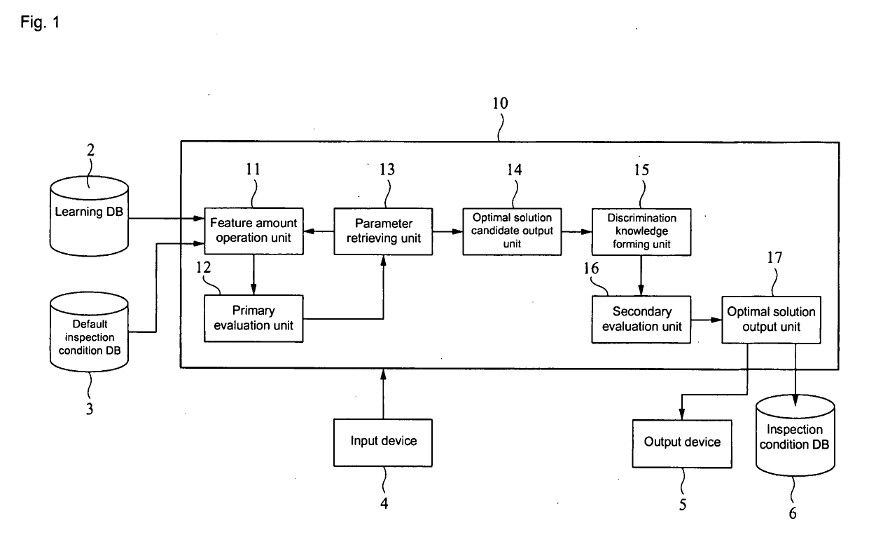

The present invention relates to an apparatus that can automatically retrieve the above-mentioned effective feature amounts and parameter sets for calculating the feature amounts based upon sample data including the results of determination as to good articles/defective articles preliminarily made (the results of determination may be made by man). FIG. 1 shows a first embodiment of the present invention.

As shown in FIG. 1, a knowledge-forming apparatus 10 is provided with a feature-amount operation unit 11, a primary evaluation unit 12, a parameter-retrieving unit 13, an optimal solution candidate output unit 14, a discrimination knowledge forming unit 15, a secondary evaluation unit 16 and an optimal solution output unit 17. Moreover, a learning data base 2, a default inspection condition data base 3, an input device 4, an output device 5 and an inspection condition data base 6 are prepared as external devices and interfaces.

The learning data base 2 is a data base that stores and maintains learning data to be used upon forming knowledge. With respect to the learning data, actual waveform data and inspection management files used for specifying the contents of the waveform data are prepared.

The actual waveform data is data formed by sensing vibrations, sounds or the like generated in an inspection/diagnosis object. For example, in this data, waveform data of generated sounds, that is, measured data, is recorded in files, and one file per one measurement is formed. Each file has an independent file name (inspection ID).

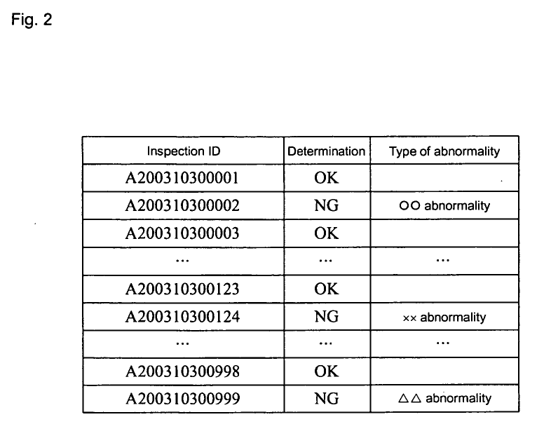

The inspection management file is a file formed by making each waveform data file associated with the results of normal/abnormal determination. Information relating to abnormality types (names or abnormal codes) is further added to the abnormal waveform data. FIG. 2 shows one example of a specific data structure, which forms a table in which an inspection ID (or file name) for specifying waveform data to be used for parameter retrieval, determination results and abnormality types are associated with one another. By using this inspection ID as a key, corresponding waveform data can be referred to. Here, the determination as to normal/abnormal may be made by an inspector (man), or may be formed and revised based upon abnormal information relating to the object thereafter.

A default inspection condition file 3 is a file in which the initial set values of respective parameter sets for retrievals at the time of the start of the retrieval are written. The feature-amount value is calculated based upon these inspection conditions. Here, this default inspection condition file 3 is not necessarily required. In this case, the initial set values of the respective parameter sets for retrievals at the time of the start of the retrieval are randomly set.

The learning data (sample data) stored in the learning data base 2 and the initial set values stored in the default inspection condition data base are given to the feature-amount operation unit 11. Here, the input device 4 is a device through which various parameter sets for retrieval are input by the user, and various input devices such as a keyboard and a mouse may be used. Moreover, the user gives instructions concerning retrieval completion conditions, retrieving means (GA, NN, Round Robin, SVM) and the like to the knowledge-forming apparatus 10 by using the input device 4.

The output device 5 is prepared as an apparatus of various types such as a display device and a printing device. The final knowledge (inspection conditions), formed by the knowledge-forming apparatus 10, is output to the output device 5. Moreover, the inspection condition data base 6 stores an inspection condition (optimal solution) finally found.

The feature-amount operation unit 11 updates a plurality of parameter sets of the inspection condition files in accordance with the results of retrieval carried out by the parameter-retrieving unit 13, and calculates the feature amounts with respect to the respective waveform data files. In the initial state of processes without any data retrieved by the parameter-retrieving unit 13, the feature amounts are calculated based upon the initial set value acquired from the default inspection condition file 3. The feature amounts are transmitted to the primary evaluation unit 12.

The primary evaluation unit 12 calculates the effectiveness (evaluated value) of each of the parameter sets from the results of the calculations on the feature amounts on each of the waveform data files through an evaluation expression which will be described later, as a temporary evaluation for knowledge to be formed. With respect to the group of feature amounts that share the same parameter or parameters in their parameter sets, it provides a weighted sum with weights as the evaluated value by using weights that are set by the parameter-retrieving unit 13.

The parameter-retrieving unit 13 retrieves the respective parameter sets (feature-amount calculation parameter sets and weights of evaluated values for the respective feature amounts) that can separate good articles (OK articles) and defective articles (NG articles) most effectively, based upon the respective parameter sets of the inspection condition files. The retrieving method includes various methods such as GA (genetic algorithm), NN (neural network), SVM (support vector machine) and Round Robin. Moreover, the parameter-retrieving unit 13 acquires a primary evaluated value from the primary evaluation unit 12, and determines whether or not the value has satisfied the completion conditions of the primary retrieval given from the input device 4. In the case when the completion conditions of the primary retrieval have been satisfied, the retrieval for the parameter sets is completed. In the case when the completion conditions have been satisfied, among the parameter sets formed through the retrieval at that time, a plurality of parameter sets that satisfy the conditions are transmitted to the optimal solution-candidate output unit 14.

Among the parameter sets acquired from the parameter-retrieving unit 13, the optimal solution-candidate output unit 14 outputs a plurality of parameter sets having high primary evaluated value as the results of primary evaluation, as optimal solution candidates (Pareto solutions).

The discrimination knowledge forming unit 15 forms a plurality of knowledge (discrimination rules) used upon carrying out an abnormal sound inspection by using the optimal solution candidates output from the optimal solution candidate output unit 14. The plurality of knowledge are given to the secondary evaluation unit 16.

The secondary evaluation unit (discrimination knowledge evaluation unit) 16 executes evaluations (secondary evaluation) on each of the plurality of knowledge formed by the discrimination knowledge forming unit 15 based upon standards such as an undetected rate and an excessive inspection rate. In other words, it calculates a secondary evaluated value for each of the plurality of knowledge in accordance with an operational expression, which will be described later. Here, a standard referred to as “discrimination error rate”, which simply discriminates whether the discrimination result is right or not, without discriminating errors due to such undetected rate and excessive detection rate, may be used.

The optimal solution output unit 17 acquires the results of the secondary evaluation, and determines the knowledge or plurality of knowledge that provides the highest secondary evaluated value as the optimal solution. The optimal solution is output to the output device 5, or stored in the inspection condition data base 6. Alternatively, the knowledge may be listed on the output device 5 (display device or the like) in the order of higher secondary evaluated values so that the user is allowed to select.

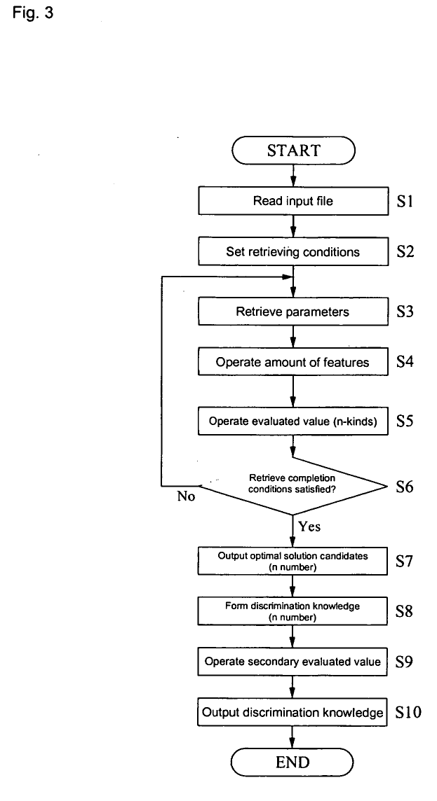

Next, the following description will discuss the functions of the respective processing units in detail, while explaining the operational principle of the above-mentioned apparatus. The processing algorithm as a whole is indicated by a flow chart shown in FIG. 3. First, input files are read from the learning data base 2 (S1). In this process, in accordance with an instruction from the input device 4, an inspection management file as shown in FIG. 2 is acquired, and waveform data files corresponding to the inspection ID stored in the inspection management file are read. After the reading process, OK/NG information stored in the inspection management file 2 is made associated with the respective waveform data files. It is determined by an instruction from the input device 4 whether all the data is acquired or specific abnormality types and normal data are read. These input files are given to the feature-amount operation unit 11.

Next, with respect to all the data, sensor data files of NG articles are collected for each of NG types (abnormality types) (ST3). In other words, as shown in FIG. 2, in the inspection management file, since data files with the results of determination being NG (abnormal) are registered in association with the types of the corresponding abnormality, those respectively having the same abnormality type are classified into the same group. Then, each time a file is called for, combinations between all the waveform data files of OK articles and waveform data files of a single NG type (waveform data file of the same abnormality type) are formed. Of course, in the case when a simple discrimination as to OK and NG is sufficiently made, it is not necessary to collect data for each of the NG types, and all the NG types may be accumulated collectively into one group.

Next, in accordance with an instruction from the input device 4, retrieval conditions are set (S2). The retrieval conditions include a retrieving method, a retrieval completion condition and the like. The retrieval completion condition is a condition based on which a determination is made as to whether or not the retrieving process is completed, and, for example, either the case in which the primary evaluated value exceeds a fixed reference value (beyond evaluated value) or the case in which the number of retrievals exceeds a fixed number (beyond set number) is selected, and a threshold value (evaluated value/number) that satisfies the selected completion condition is set. Here, the retrieval completion condition may be made by selecting either one of these, or both of the conditions may be specified, and when either one of the conditions is satisfied, the retrieval may be completed. With respect to the retrieval method, selection is made as to whether the separation degree is preferentially used or the separation number is preferentially used. In the case when the separation number is preferentially used, it is specified how many upper ranks are utilized, and the coefficient of each of weights is also specified.

Various algorithms used for carrying out parameter retrievals are proposed, and in the present embodiment, a genetic algorithm (GA) is used. With respect to the parameter sets that specify the operation of a genetic algorithm, the number of specimens, the cross rate, the rate of mutation and the number of generations are included. The number of specimens corresponds to the number of respective specimens (solution candidates) to be used for the retrieval. The cross rate corresponds to a possibility at which the respective specimens are made to cross with each other. The rate of mutation corresponds to a possibility at which a gene in each of the specimens is mutated. The number of generations corresponds to the number of generations to which the genetic algorithm is applied. These parameter sets may be preliminarily set in the parameter-retrieving unit 13, or may be input thereto from the input device 4 and the default inspection condition data base 2. Moreover, among the above-mentioned retrieval completion conditions, the number, which is specified by the “beyond number” operation, corresponds to the number of generations of the genetic algorithm. For example, the above-mentioned various conditions are set by the user through operations from the input device 4. The set conditions are given to, for example, the parameter-retrieving unit 13 and the respective evaluation units 12 and 16.

Next, the parameter-retrieving unit 13 retrieves the parameters (ST3). In the first time, this parameter-retrieving process acquires a default parameter sets through the feature-amount operation unit 11, and forms an initial specimen and returns this to the feature-amount operation unit 11. Here, the initial specimen may be formed at random. Moreover, with respect to the parameter-retrieving processes in the second time and thereafter, new specimens are formed through cross and mutation. Moreover, a specimen having a low evaluation is replaced with a new specimen.

In other words, when a genetic algorithm is used as the algorithm for retrieving parameter sets, individual parameters are recognized as genes and the parameter sets are recognized as specimens. Thus, while new specimens are formed through cross and mutation of specimens, better specimens are left so that a specimen close to the optimum is obtained. Here, parameter retrieving processes to be carried out in the second time and thereafter will be described later.

Based upon respective specimens (respective parameter sets used for calculating the feature amount) received from the parameter-retrieving unit 13, the feature-amount operation unit 11 calculates various feature amounts as described in Japanese Patent Application Laid-Open No. 11-173909 (ST4). The calculations are carried out on the waveform data of all the files that are regarded as OK through the results of determination and on the waveform data of all the files of a single NG type, among the waveform data that are input at step S1, and the calculated value (feature amount) is sent to the primary evaluation unit 12. this calculating process of the feature amount is carried out for each of the specimens.

The primary evaluation unit 12 calculates n-number of primary evaluated values for each specimen (each parameter set) using various operational expressions (as described later) and outputs n-number of parameter solutions (parameter sets) each having the greatest primary evaluated value under the respective operational expressions. First, the following description will discuss the case in which one evaluated value is found for each of the specimens. In other words, an evaluated value eli for each feature amounts is calculated by using an expression (1). In this case, the subscript “i” represents a feature-amount number that specifies the feature amount, and is given as an integer in a range from 1 to the number of the feature amounts. Moreover, the coefficient a in the following expression (1) is a coefficient that the value is increasing in the case when the average of the waveform data that are regarded as OK in the inspection management file (hereinafter, referred to as OK article) is smaller than the average of the waveform data that are regarded as NG in the inspection management file (hereinafter, referred to as NG article), that is, in the case when the NG articles are detected at a higher value. In contrast, the coefficient β is a coefficient that the value is increasing in the case when the group of OK articles and the group of NG articles are completely separated. When the overlapped portion of the two distributions of OK articles and NG articles is not present (as it becomes smaller), the evaluated value becomes greater.
eli=α×β×(μng·μok)/σok (1)
In this expression, a takes any one of 0, 100 and −10 depending on the following conditions, and

0: σok=0,

100: σok>0 and MINng−MAXok>0,

−10: σok>0 and MINng−MAXok≦0,

β takes either 2 or 1 depending on the following conditions:

2: MINng−MAXok>0,

1: MINng−MAXok≦0

wherein:

μng: average value of the result of calculations of the amount of features of NG articles,

μok: average value of the result of calculations of the amount of features of OK articles,

σok: dispersion of the result of calculations of the amount offeatures of OK articles

MAXok: the maximum value of the feature amounts of OK articles

MINng: the minimum value of the feature amounts of NG articles

Next, the evaluated value eli of each feature amounts, found based upon the above-mentioned expression (1), is assigned to the following expression (2) so that a primary evaluated value E is calculated on the specimen (each parameter set) with the entire feature amounts being taken into consideration. Here, E represents a weighted sum of the evaluated values of all the feature amounts.
E=Σ(wi×eli) (2)

wherein wi is i-numbered weight of the feature amount, and

1≦i≦(number of feature amounts).

In actual operations, the primary evaluation unit 12 finds n-number of primary evaluated values with respect to each of the specimens (respective parameter sets), and outputs n-number of parameter solutions (parameter sets) each having the greatest primary evaluated value. With respect to the method for finding n-number of primary evaluated values for n-number of individual specimens in this manner, for example, one evaluated value e1 is found for each of the feature amounts specified by each specimen by using the expression (1), and n-number of combinations of weights for each of the feature amounts used upon finding the primary evaluated value E are prepared (a plurality of types of Wi of the expression (2) are prepared) so that n types of different primary evaluated values E can be obtained.

Moreover, as another evaluated value operation expression, the following primary evaluated value E′ or the like in which only one of the greatest feature amounts is taken into consideration is prepared so that n-number of primary evaluated values can be found, with the number of combinations of weights of the expression (2) being made smaller than n.
E′=Max(eli)

In the reversed manner to the above description, n-number of operation expressions, each used for finding the evaluated value ex (x is an integer of 1 to n) of the specimen based upon each of the feature amounts corresponding to the expression (1), may be prepared. In this case, the primary evaluated value E concerning the specimen (parameter set) in which the entire feature amounts are taken into consideration is prepared, for example, by using the expression (2), and only one combination of weights with respect to each of the feature amounts is required. With respect to another expression for the evaluated value operation, for example, the following expressions (1)′ and (1)″, which are simplified forms of the expression (1), may be used to find respective evaluated values e2 and e3.
e2=|μng−μok|/σok (1)′

(which is formed by paying attention to a difference between OK articles and NG articles as well as to deviations in OK articles so that the evaluated value e2 becomes greater as the deviations in the values of feature amounts among the mutual OK articles become smaller.)
e3=|μng−μok| (1)″

(which is formed by paying attention only to a difference between OK articles and NG articles so that the evaluated value e3 becomes greater as the difference between the average values of feature amounts of the OK articles and NG articles becomes greater.)

Of course, evaluated values other than these may be adopted, and by preparing a predetermined number of combinations of weights for the respective feature amounts upon finding the primary evaluated value E (by preparing a plurality of types of Wi in the expression (2)) with respect to these three types of evaluated values ex (x is 1, 2 or 3), n-types of different primary evaluated values E can be found. Moreover, only one type of the operational expression of the primary evaluated value (only one combination of weights to each of the feature amounts) is used, and a plurality (n-number) of parameter solutions may be output in the order of higher evaluated values. Then, each specimen (each of the parameter sets) and n-types of primary evaluated values found for each of the specimens are stored and maintained in association with each other.

After n-types of the primary evaluated values have been found based upon the above-mentioned expressions, a retrieval completion condition determining function in the parameter-retrieving unit 13 checks for whether or not the retrieval completion condition has been satisfied (ST6): The retrieval completion condition, which is set through the input device 4 in step 2, for example, includes a state in which the evaluated value has exceeded a predetermined level and a state in which the number of generations has reached a predetermined value. Here, when the retrieval completion condition has not been satisfied, the sequence returns to step 3 so that based upon the primary evaluated value, the parameter-retrieving unit 13 retrieves the next one of the parameter sets, and sends the result of the retrieval to the feature-amount operation unit 11 (ST3). Thereafter, the sequence returns to S4 where the feature-amount operation unit 11 calculates the feature amount based upon the new one of the parameter sets.

Here, in the present embodiment, upon executing step S5, all the primary evaluated values obtained are stored and maintained; however, the best solution for each of the types may be maintained. In other words, upon receipt of the primary evaluated value from the primary evaluation unit 12, the parameter-retrieving unit 13 compares the value with the greatest primary evaluated value of the current one of the parameter sets of the corresponding type, and when the primary evaluated value received this time is greater, the greatest primary evaluated value of the type is updated so that the current one of the parameter sets is maintained as the best solution candidate.

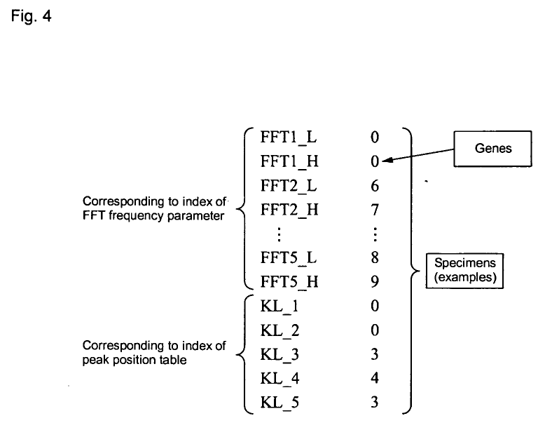

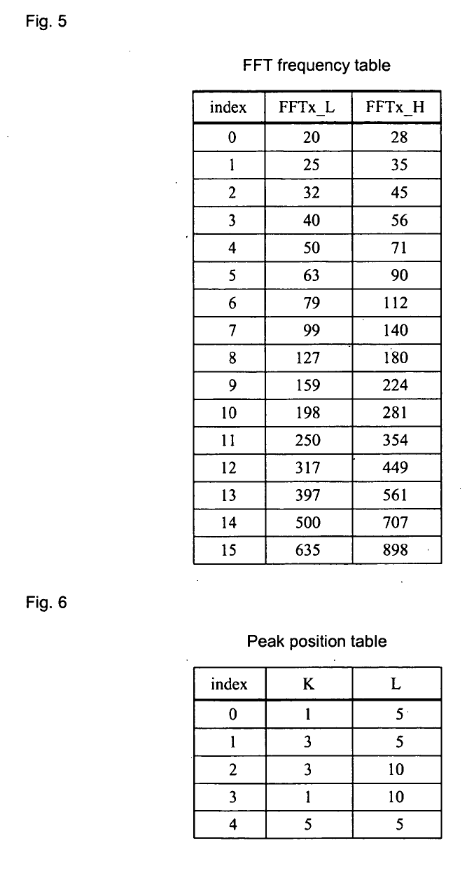

The following description will discuss functions of the parameter-searching unit 15. FIG. 4 shows an example of coding of respective specimens when a genetic algorithm is adopted in the parameter-retrieving unit 13. The values of respective genes in this coding system respectively correspond to table indexes in FIGS. 5 and 6. Here, with respect to the feature amount, among the frequency spectral peaks of FFT within the frequency range from FFTx_L to FFTx_H, the average value of L-number of peaks from the K-numbered peak that are specified by KL_x is defined as the feature amount.

Therefore, for example, when x=2, FFT2_L (FFT lower-limit frequency) and FFT2_H (FFT upper-limit frequency) indicate that FFT frequency spectrums between 79 Hz-140 Hz are calculated to find the feature amount. Moreover, KL_{—}2 indicates that five peaks from 1^{st} peak of frequency spectral peaks obtained through FFT2_L and FFT2_H are averaged.

Similarly, in the case when x=1, since FFT1_L and FFT1_H are the same value 0, the FFT frequency spectrums from 20 to 28 Hz are found, and five peaks from 1^{st} peak of the resulting frequency spectral peaks are averaged.

A large number of specimens of genes coded as described above are generated randomly as an initial group, and selections and eliminations are carried out by using a genetic algorithm, and crossing and mutation operations are conducted on demands to retrieve a parameter that forms the optimal solution. The parameter-retrieving unit 13 carries out genetic operations such as selection, elimination, crossing and mutation operations in such a genetic algorithm so that genes (respective parameter sets) of a new generation are generated.

With respect to the genetic algorithm to be utilized, those generally used may be used. In other words, based upon operation conditions (number of specimens, number of generations and the like) determined by the retrieval condition setting unit 14, the initial group (0 generation) is generated. Then, based upon the respective parameter sets thus set, the feature amount is found by the feature-amount operation unit 11, and the results are estimated in the primary evaluation unit 12.

Next, two superior specimens are selected from the current group. This selection is made so as to allow those specimens that adapt to the environment to survive, and those having high evaluation values tend to have a higher possibility of surviving. In the present embodiment, a roulette system is adopted in its specimen (parent) selection system. This roulette system is a system in which the possibility of the specimen being selected is in proportion to the evaluated value of the specimen. More specifically, indexes used for recognizing specimens are set to 0 to n, and supposing that the evaluated value of a specimen i is fit (i), the specimen j that satisfies the following expression is selected.

$$T\_val = RAND ( 1 ) \times {\sum }_{i = 0}^{n} fit ( i ) \\ {\sum }_{i = 0}^{j} fit ( j ) > T\_val \qquad [ Expression 1 ]$$

where
j: 0=>n
0<=RAND(1)<1.0

In other words, a numeric value (T_val) less than the sum of the evaluated values is generated at random. Next, the evaluated values are added in the order of indexes, and the specimen having an index exceeding T_val is selected.

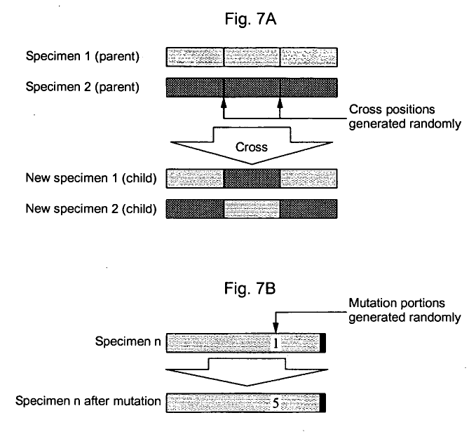

In the case when the crossing possibility is exceeded, a crossing operation is carried out. In other words, from the two specimens (parent) selected as described above, two new specimens (children) are generated. With respect to the crossing method, a two-point crossing method is adopted. In other words, as shown in FIG. 7A, a crossing position is determined at random, and data at the crossing position are exchanged for each other. Since the new specimens thus generated are generated from the parent of two superior specimens, it is assumed that the two will take over superior features from the parent.

In the case when the mutation rate is exceeded, the specimen is mutated. The mutation is an operation in which a feature that is not possessed by the specimens of the parent is generated in a child specimen. In other words, as shown in FIG. 7B, the value of a gene at a mutation portion determined at random is replaced by a mutation value determined at random. Here, the mutation value is generated at random in a range between the upper and lower limit values of the selected gene. In other words, for example, in FIG. 4, genes from the leading portion to the 10^{th} one that specify the FFT frequency parameter are determined within a range from 0 to 15, and the latter five genes that specify the peak position table are determined within a range from 0 to 4.

Moreover, two specimens having the lowest evaluated value are selected, and replaced with the new specimens generated through the above-mentioned crossing or mutation operation. Thus, exchanges for generation are carried out. The above-mentioned processes are carried out on the entire specimens. Moreover, by repeatedly executing the above-mentioned exchange for generation appropriate number of times, the best specimen can be determined.

In the case of Yes in the branched determination at step S6, the parameter retrieval in the parameter-retrieving unit 13 is completed; therefore, the optimal solution candidate output unit 14 acquires a specimen (each parameter) of each generation from the parameter-retrieving unit 13 and primary evaluated values (n-number) with respect to the specimen found by the primary evaluation unit 12, and detects a specimen having the greatest value for each of the n-number of the primary evaluated values so that the parameter sets constituting each of the specimen detected are outputted to the discrimination knowledge forming unit 15 as optimal solution candidates (S7). In other words, n-number of optimal solution candidates are outputted.

As described above, in the case when, upon executing step 5, instead of storing and holding all the primary evaluated values acquired, the best solution for each of the types is stored, since, upon completion of the parameter retrieval in the parameter-retrieving unit 13, a specimen (the parameter) having a high primary evaluated value and its primary evaluated value are stored for each of the types, these may be read and outputted to the discrimination knowledge forming unit 15 at the succeeding stage. Here, the specific value of the primary evaluated value is not particularly outputted.

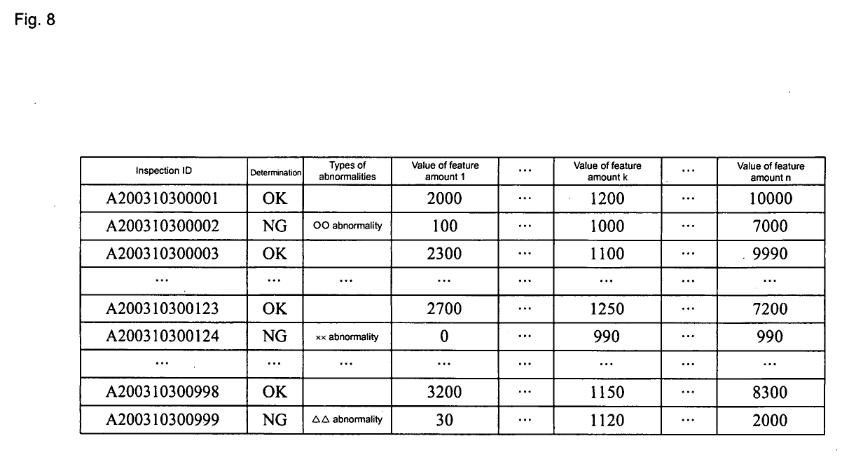

Moreover, with respect to each piece of inspection data, the optimal solution candidate output unit 14 forms output data (see FIG. 8) on which the value of each of the feature amounts calculated by using a set of parameter sets (optimal solution candidates) is described for each set of parameter sets, and outputs the resulting data.

Next, based upon the respective parameter sets (values of the feature amounts, parameter sets and the like) forming the n-number of specimens acquired and the output data, the discrimination knowledge forming unit 15 forms discrimination knowledge for each of the specimens (S8). Upon forming the discrimination knowledge, first, an effective feature amount (feature amount in which OK data and NG data are easily separated) is found, and knowledge is formed based upon the effective feature amount. The knowledge to be formed here can be made through various methods, such as a method in which a threshold value for separating OK and NG is set for each of the feature amounts and a method in which a membership function and a fuzzy rule are set by using the effective feature amount. By using these method, n-number of pieces of discrimination knowledge are formed and a created knowledge name (identification ID) is given to each piece of knowledge.

The n-number of pieces of discrimination knowledge thus created are given to the secondary evaluation unit 16 so that a secondary evaluated value eval is found for each piece of discrimination knowledge (S9). Here, the discrimination knowledge is quantitatively evaluated by paying attention to how often an excessive detection (over inspection) that determines OK articles as NG articles and an undetected erroneous discrimination that determines NG articles as OK articles occur depending on the discrimination knowledge created. More specifically, the resulting value is found by using the following expression (3).
eval=100−w1×excessive detection rate−w2×undetected error rate (3)

wherein w1 and w2 indicate weights for the excessive detection rate [%] and the undetected error rate [%] respectively.

Excessive detection rate and undetected error rate for one discrimination knowledge can be calculated respectively through the following processes: conducting NG/OK determinations based upon the discrimination knowledge on each waveforn data associated with the inspection ID listed in the output data output from the optimal solution candidate output unit 14, checking the conducted determinations against the given determinations in the output data, and adding up the respective erroneous, that is, “excessive detection” or “undetected error”.

Of course, not limited to the above-mentioned methods, the secondary evaluated value can be obtained by using various expressions, such as an expression in which the excessive detection and the undetected error are not distinguished (for example, eval′=100−discrimination error rate).

The optimal solution output unit 17 acquires the secondary evaluated value for each of the pieces of created knowledge obtained in the secondary evaluation unit 16, and finally determines the created knowledge having the highest evaluated value as the best created knowledge (final knowledge), and outputs the resulting knowledge (S10). The output end is the output device 5, such as a display device, on which the final knowledge is outputted and displayed, or the inspection condition data base 6 in which the final knowledge is stored. Moreover, the optimal solution output unit 17 may direct the final knowledge to a printing machine (the output device 5) so as to be printed out, or may send it to a noise detection system in which parameter sets and the like are directly set.

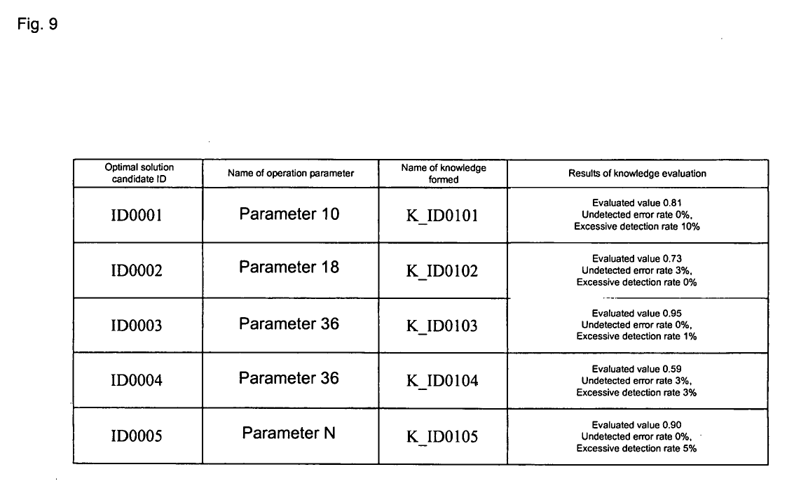

Moreover, by executing the processes up to step S9, a table having a data structure, for example, shown in FIG. 9 can be formed. In other words, with respect to the optimal solution candidates obtained in the primary evaluation, the table describes the discrimination knowledge created based upon them and the results of evaluation on the knowledge. The table is also stored in the inspection knowledge data base 6 or another predetermined storage device. By forming the table of this type, for example, an optical solution candidate ID is used as a key so that the corresponding operational parameter and created knowledge can be referred to.

In the above-mentioned embodiment, simultaneously with the parameter retrieval, weights used upon finding the sum of weights of the evaluated values are also retrieved, and by using various weights, a plurality of optimal solution candidates can be found (primary evaluation). Thus, specimens (respective parameter sets), which are found by the operational expression for the primary evaluated value with great weights placed on effective feature amounts, are allowed to remain. Moreover, with respect to the outputted optimal solution candidates (constituted by a predetermined number of feature amounts and parameter sets), knowledge is actually created and the performance of the knowledge is evaluated (secondary evaluation) so that a truly optimal solution (best knowledge) can be determined.

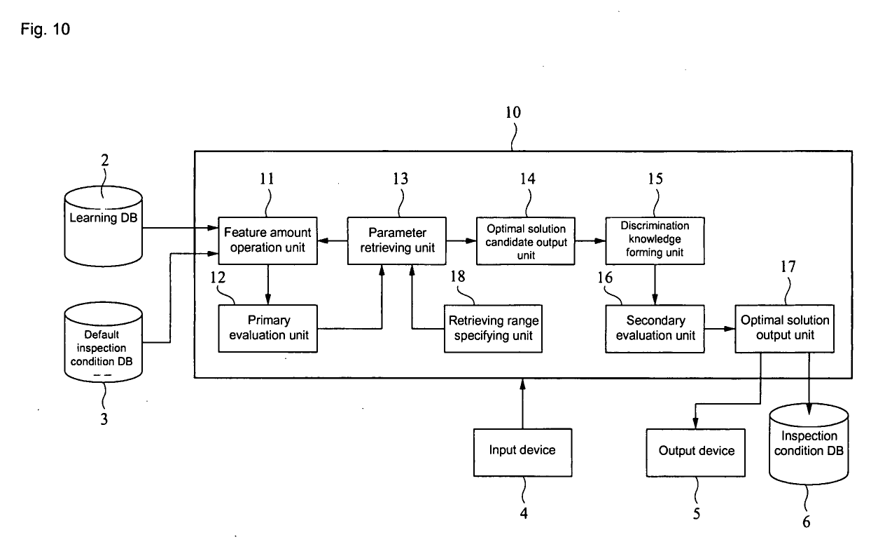

FIG. 10 shows a second embodiment of the present invention. Although the basic structure is the same as the first embodiment, the present embodiment is further provided with a retrieval feature-amount specifying unit 18. This retrieval feature-amount specifying unit 18 is used for limiting a retrieval area in accordance with an input from the input device 4. With respect to the area thus specified, a parameter retrieving process is carried out. With respect to the method for specifying the retrieval area, a method in which an feature amount to be excluded from the retrieval area is specified and a method in which an feature amount to be retrieved is specified are proposed and either of the two methods may be used. For example, when the method in which an feature amount to be excluded from the subject for the parameter retrieval and feature-amount operation is used, the retrieval feature-amount specifying unit 18 determines the parameter retrieving area based upon retrieval area specifying information acquired through the input device 4, and excludes the feature amount and the like determined to be unnecessary from the subjects for the retrieval. The feature amount and the like that have been excluded from the retrieval subjects are given to the parameter-retrieving unit 13. Moreover, feature amounts to be filtered may be limited by specifying the frequency band (at least either one of the upper limit value and lower limit value of the filter to be retrieved).

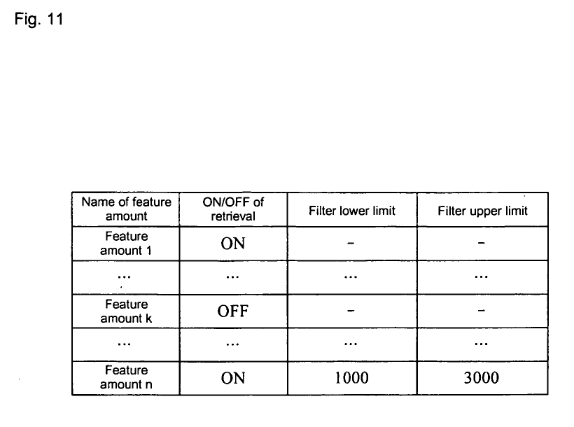

FIG. 11 shows one example of a data structure which is used for specifying a pinpointing process on the retrieval area specified by the retrieval area specifying unit 18. In other words, the retrieval operability and inoperability are respectively specified (one of these may be set as an initial value (for example, “ON”), while only the other to be set as “OFF” may be specified), or upon application of a filter, the area thereof may be specified. The retrieval area specifying unit 18 forms an inner table of this type in accordance with an instruction from the input device 4, and allows the parameter-retrieving unit 13 to specify the retrieval area, if necessary.

Specific processes of the second embodiment are executed through a flow chart shown in FIG. 12. As clearly indicated by the comparison between this flow chart of FIG. 12 and the flow chart of FIG. 3, after the processing step S2, the retrieval feature-amount specifying unit 18 successively carries out a pinpointing process of the retrieval area (S11). With this arrangement, in steps after the processing step S3, various processes are executed within the retrieval area thus pinpointed. Consequently, clearly unnecessary feature amounts, parameter areas and the like can be excluded beforehand, making it possible to find optimal final knowledge more effectively. Here, with respect to the functions of the respective processing units shown in FIG. 10 and the respective processing steps (excluding the processing step S11) of the flow chart of FIG. 12, since these are the same as those of the first embodiment, the same processing units and processing steps are indicated by the same reference numerals, and the detailed description thereof is omitted.

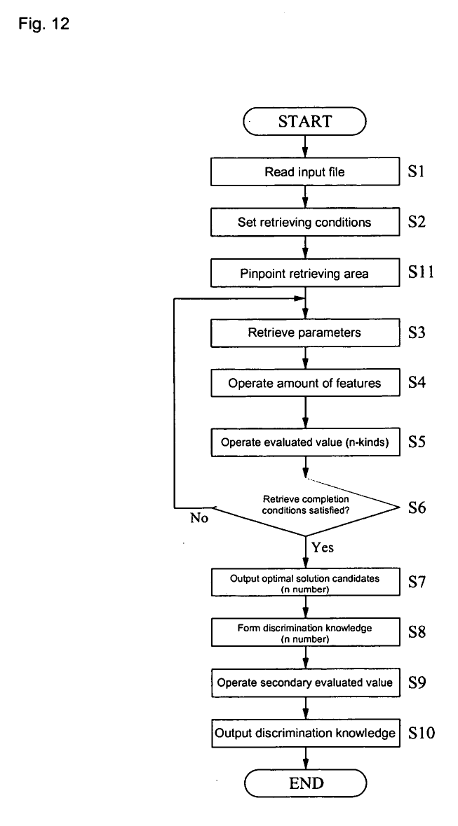

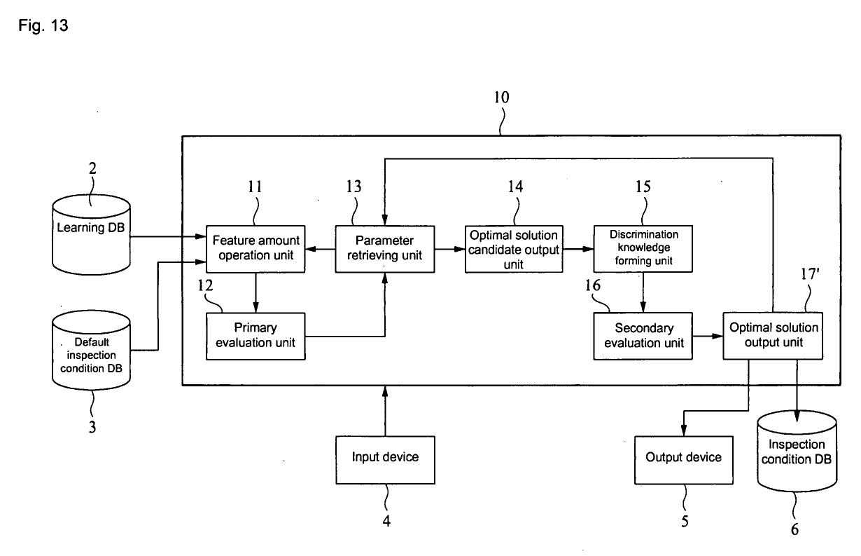

FIG. 13 shows a third embodiment of the present invention, the present embodiment is basically the same as the first embodiment, and the optimal solution output unit 17′ is further provided with a function used for determining whether or not a discrimination knowledge formation completion condition has been satisfied. Of course, the function of the optimal solution output unit 17 in the first embodiment is also prepared. This optimal solution output unit 17′ is allowed to acquire the discrimination knowledge formation completion condition, preliminarily or through the input device 4. For example, the completion condition is prepared, for example, as a point of time at which the secondary evaluated value has reached a predetermined level. When the discrimination knowledge formation completion condition is not satisfied, it instructs the parameter-retrieving unit 13 to execute the parameter retrieving process. Consequently, the parameter-retrieving unit 13 carries out the parameter retrieving process, and sends the results of retrieval to the feature-amount operation unit 11 so that the feature amount is found. In other words, the processes are again carried out from the primary evaluation. Moreover, when the discrimination knowledge formation completion condition is not satisfied and the instruction for again executing the parameter retrieval is given to the parameter-retrieving unit 13, the optimal solution output unit 17′ may give the upper m-number of parameter set solutions having good secondary evaluated values thereto together with the instruction.

The parameter-retrieving unit 13 may generate (a plurality of) first initial specimens based upon respective parameter sets acquired from the default inspection condition file 3 in the same manner as the first embodiment, or may generate these at random. The initial specimens, obtained upon receipt of the re-execution instruction from the optimal solution output unit 17′, are derived from the upper m-number of parameter set solutions having good secondary evaluated values acquired from the optimal solution output unit 17′. One portion of the initial specimens may be set based upon the m-number of good parameter sets, and the rest of them may be generated at random.

In the case of parameter retrieval using a genetic algorithm, the setting of the initial specimens gives influences to the results of parameter set solutions to be obtained. Therefore, in the present embodiment, the parameter set solutions (m number), prepared at the time when pieces of discrimination knowledge (upper m number) having high secondary evaluated values are obtained, are set as initial specimens for the next parameter retrieval so that better parameter set solutions are prepared and discrimination knowledge is effectively obtained.

In this case, of course, without feeding back the results of the secondary evaluation, the parameter retrieving process may be simply executed again. This is because, in the parameter retrieval using a genetic algorithm, by generating the initial specimens at random, it is possible to obtain the results of parameter retrieval different from those of the last time. Moreover, even when the initial specimens are the same as those obtained last time, the results lastly obtained are made different because of mutation and the like applied upon parameter retrieval. Therefore, until the discrimination knowledge formation completion condition has been satisfied, the processes from the primary evaluation to the secondary evaluation are repeatedly executed so that a parameter set solution having a secondary evaluated value that satisfies the completion condition can be formed.

Of course, the discrimination knowledge formation completion condition is not limited to the condition for limiting the secondary evaluated value to a predetermined level or more as described above, and, for example, another condition is prepared in which: the number of repetitions is set and the processes from the primary evaluation to the secondary evaluation are executed so that the resulting secondary evaluated value and the corresponding parameter sets are stored and maintained, and after having repeated the processes several times, that having the highest secondary evaluated value may be defined as optimal final knowledge. Moreover, various condition settings are available, and, for example, still another condition may be prepared in which: “the number of repetitions” and “secondary evaluated value exceeding a predetermined level” are set as OR conditions, and at the time when, even if the repetition number does not satisfy the set value, the secondary evaluated value exceeds a predetermined level, the process is terminated.

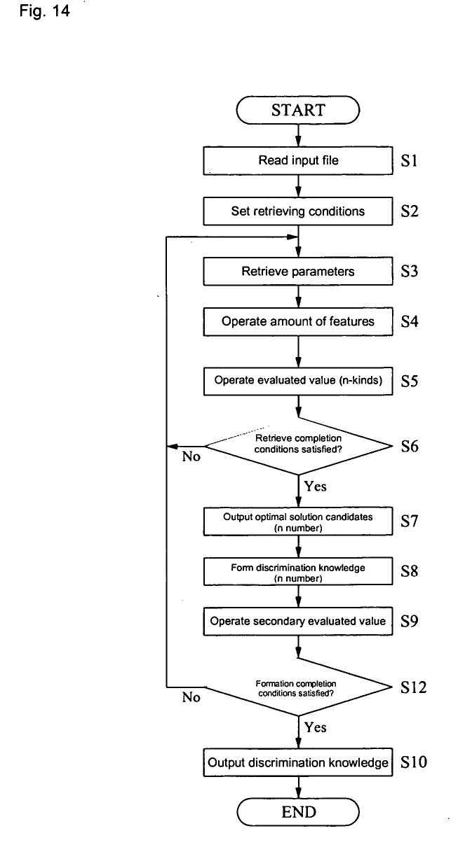

FIG. 14 shows a flow chart that explains a specific processing algorithm in accordance with the third embodiment. As clearly indicated by this Figure, after the secondary evaluated value operation process at processing step 9 of the flow chart of the first embodiment of FIG. 3, a branched determination as to whether or not the formation completion condition is satisfied is added (S12), and in the case of “No” in the branched determination with the condition being not satisfied, the sequence returns to the processing step S3 so that the processes are re-executed from the parameter retrieval. When the condition in processing step S12 is satisfied with the branched determination being set to “Yes”, the best discrimination knowledge is outputted (S10). These processing steps S12 and S10 are executed by the optimal solution output unit 17′.

In other words, in the third embodiment, the feature-amount parameter retrieval (S3 to S6) and discrimination knowledge formation (S3 to S9) are repeated and executed until the results of the secondary evaluation on the discrimination knowledge thus created have satisfied the completion condition. In other words, the feature-amount retrieval (S3) is repeated through the following double loops.
Inside loop (S3 to S5): used for optimizing the primary evaluated value on the feature-amount parameter
Outside loop (S3 to S9): used for optimizing the evaluated value (secondary evaluated value) on the discrimination knowledge

With respect to the functions of the respective processing units shown in FIG. 13 and the respective processing steps (except for processing steps S3 and S12) shown the flow chart of FIG. 14, the same processing units and processing steps as those of the first embodiment are indicated by the same symbols, and the detailed description thereof is omitted. Moreover, the third embodiment, which is constituted based upon the first embodiment, may also be constituted based upon the second embodiment.

The respective processing units can be achieved by application programs. In the respective embodiments, the respective functions have been explained as those obtained from devices installed in a computer and the like; however, the present invention is not intended to be limited by such devices, and may be prepared as software (program products) used for achieving required processing functions. Thus, the program products may be supplied through various communication lines, or may be stored in various recording media so that these may be distributed.

### EXAMPLES

Based upon the first embodiment, the following description will explain specific examples. First, the feature amounts to be used in the present examples are defined as two factors, that is, PN (PeakNumbers) and PV (PeakValue).

Here, the feature-amount PN value is given by the number of peaks at which the value of waveform s(t) exceeds a threshold value (specified by a parameter PT) within a range of time t (upper value and lower value are specified by parameter sets TL and TH). The feature-amount PV value is given as a peak value (value, s (t), on the axis of ordinates) located on a certain order (the order is specified by parameter RP) within a range of time t (upper value and lower value are specified by parameter sets TL and TH). Here, the parameter sets TL and TH that specify the range of time are commonly used in the feature-amount PN and PV values.

Four parameter sets, that is, TL (TimeLow), TH (TimeHigh), PT (PeakThreshold) and RP (Rank of Peaks), are used in this case.

The parameter TL, which is commonly used in the feature-amount PN and PV values, represents the lower limit value of a range of time t to which attention needs to be paid within the waveform data s(t). The parameter TH, which is commonly used in the feature-amount PN and PV values, represents the higher limit value of a range of time t to which attention needs to be paid within the waveform data s(t). The parameter PT is used for the feature-amount PN value, and represents a threshold value of the peak value. Only the peaks exceeding this threshold value are counted as the feature-amount PN value. The parameter RP is used for the feature-amount PV value, and specifies a peak to which attention needs to be paid in the order (decrement order of the values) of the peak values. In other words, the peak value that is the RP-th highest forms the feature-amount PV value.

FIG. 15 shows one examples of the results of calculations based upon these two feature-amount values and four parameter sets. FIG. 15A shows a state in which parameter sets TL=1.0, TH=4.0, PT=2.0 and RP=1, and in this case, since the feature-amount value PN is given by parameter PT=2.0, the number of peaks exceeding the s(t) value 2.0 is three. Since parameter RP=1 holds, the feature-amount value PV corresponds to 4.0, which is the first peak value in the order.

In the same manner, FIG. 15B shows a state in which parameter sets TL=1.0, TH=3.0, PT=2.0 and RP=1, and in this case, since the feature-amount value PN is given by parameter PT=2.0, the number of peaks exceeding the s(t) value 2.0 is two. Since parameter RP=1 holds, the feature-amount value PV corresponds to 3.2, which is the first peak value in the order.

In this manner, when the settings of the parameter sets (in the above-mentioned example, the combinations of parameter values TL, TH, PT and RP) change, the feature-amount values (PV and PN) also change. Therefore, the settings of the parameter values need to be set so as to separate good articles and defective articles based upon the feature-amount values; however, in the case when a plurality of feature amounts share the parameter sets, the setting of the parameter value prepared so as to increase the degree of separation of one of the feature amounts tends to cause a reduction in the degree of separation of the other feature amount (=competitive relationship), making it difficult to optimize all the feature amounts.

Next, on the assumption that the above-mentioned feature amounts and the parameter sets are used, the processing step S1 of FIG. 3 is executed, with four waveform data (data ID: W01, W02, W03, W04) inputted as learning data. The results of the determination indicate that W01 and W02 are OK and that W03 and W04 are NG The processing step S2 is executed, and retrieval conditions are inputted. More specifically, the completion condition is set so that the number of retrievals=2 and the retrieving method is set so that priority is given to the number of separations (two feature amounts are used with the weights of evaluation being set to 1:1).

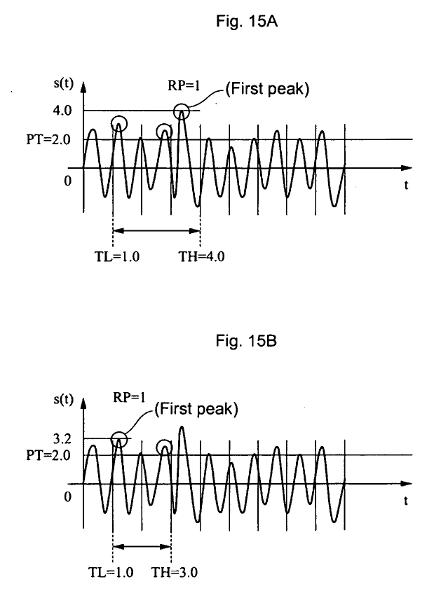

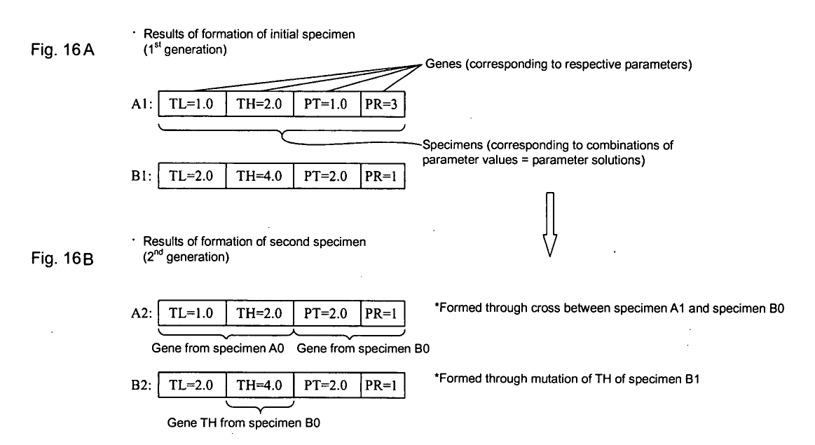

The parameter-retrieving process (S3) is executed, and supposes that parameter sets as shown in FIG. 16 are obtained. Here, FIG. 16A indicates initial specimens, and suppose that two specimens A1 and B1 have been generated randomly. Then, suppose that specimens A2 and B2 have been generated as shown in FIG. 16B through the next parameter retrieval.

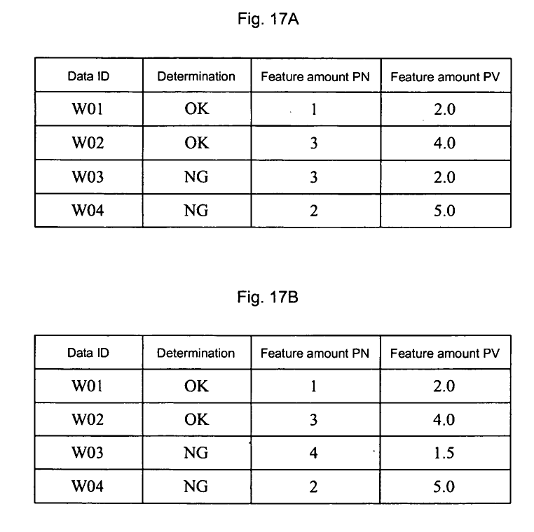

In the processing step S4, the respective feature-amount values in the above-mentioned A1, A2, B1 and B2 are found with respect to the respective waveform data. For convenience of explanation, the feature-amount values in A2 are indicated by FIG. 17A and the feature-amount values in B2 are indicated by FIG. 17B.

Next, a primary evaluated value is found (S5). For example, the PN value of A2 is found through the following expressions:
μng=(3+2)/2=2.5, μok=(1+3)/2=2.0
σok={(1−2.5)ˆ2+(3−2.5)ˆ2}/(2−1)=2.0
MINng−MAXok=2−3=−1, α=−10, β=1

Therefore, the following equation holds:
e1=−10×1×(2.5−2.0)/2.0)=−2.5

In the same manner, the evaluated value on the feature-amount value PV is represented by:
e=−2.5

In the same manner, when the respective values are found on B2, the evaluated value on the feature-amount value PN is represented by: e=−5.0, and the evaluated value on the feature-amount value PV is represented by: e=−1.25. Moreover, the final primary evaluated value is represented by:
E=1.0×(−5.0)+1.0×(−1.25)
=−6.3

Next, primary evaluated values E of a plurality of types are found, and the following two types of settings are used as a combination of weights for the operational expression:
(a) w1=w2=1.0 (simple sum) ->set as evaluated value Ea
(b) the feature amount with a higher value of e is indicated by w=0.75, and that with a lower value is indicated by w=0.25 ->set as evaluated value Eb

Therefore, with respect to A, since the following values are obtained:

Evaluated value e on the feature-amount PN e=−2.5

Evaluated value e on the feature-amount PV e=−2.5,

the following expressions hold:

Evaluated value Ea=1.0×(−2.5)+1.0×(−2.5)=−5.0

Evaluated value Eb=0.25×(−2.5)+0.75×(−2.5)=−2.5

Moreover, with respect to B, since the following values are obtained:

Evaluated value e on the feature-amount PN e=−5.0

Evaluated value e on the feature-amount PV e=−1.25,

the following expressions hold:

Evaluated value Ea=1.0×(−5.0)+1.0×(−1.25) =−6.3

Evaluated value Eb=0.25×(−5.0)+0.75×(−1.25)=−2.2

Therefore, with respect to the evaluated value Ea, the parameter set solution A2 is outputted, and with respect to the evaluated value Eb, the parameter set solution B2 is outputted as an optical solution candidate (S7).

Upon forming discrimination knowledge on each of optimal solutions, with respect to A2, the following discrimination knowledge is obtained:

Discrimination knowledge XA:

“IF feature-amount PN≧3.0 AND feature-amount PV≧4.5

THEN defective article (NG)” and with respect to B2, the following discrimination knowledge is obtained:

Discrimination knowledge XB:

“IF feature-amount PN≧3.5 AND feature-amount PV≧4.5

THEN defective article (NG)”

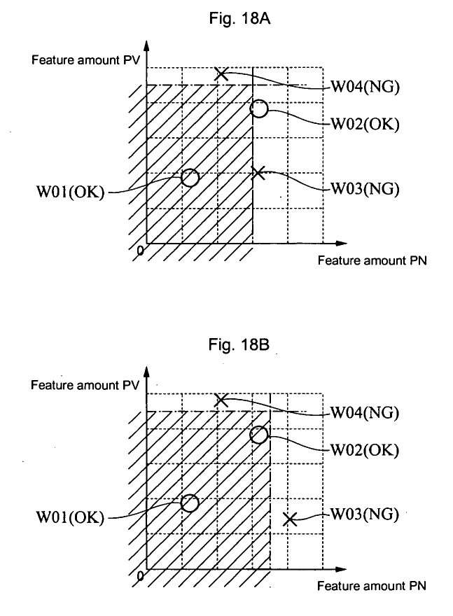

These are indicated as shown in FIG. 18.

For each of the cases, the rates of excessive detection (OK is erroneously determined as NG) and undetected error (NG is erroneously determined as OK) are found and indicated as follows:

With respect to A2:

Excessive detection rate=

(OK cases erroneously determined as NG)/(all OK cases)

=1/2=0.5

Undetected error rate=

(NG cases erroneously determined as OK)/(all NG cases)

=1/2=0.0

With respect to B2,

Excessive detection rate=0/2=0.0

Undetected error rate=0/2=0.0

Moreover, the evaluated value (=secondary evaluated value) eval on the discrimination knowledge is calculated in the following manner (weights w1 and w2 for the excessive detection rate and undetected error rate are respectively set to 0.1 and 0.9):
With respect to A2:

$$\begin{matrix}\begin{matrix}Secondary evaluated \\ value eval\end{matrix} = 1.0 - w 1 \times excessive detection rate - \\ w 2 \times undetected error rate \\ = 1.0 - 0.1 \times 0.5 - 0.9 \times 0.0 \\ = 0.95\end{matrix}$$

With respect to B2:

Secondary evaluated value eval=1.0−0.1×0.0−0.9×0.0

=1.0

Consequently, the knowledge relating to B2, which is lower than A2 in the evaluation as the primary evaluated value, is determined as final detection knowledge.

This is also clearly indicated by FIG. 18. In other words, in FIG. 18A relating to A2, no threshold value used for separating defective (NG) data W03 from good (OK) data can be set; however, in FIG. 18B relating to B2, the threshold value used for separating defective (NG) data from good (OK) data can be set.

In other words, supposing that only the evaluated value of one type is used, only A2 having a high primary evaluated value is selected, with the result that it is not possible to create sufficiently effective knowledge in this case; however, in the present embodiment, evaluated values of a plurality of types are used so that a plurality of parameter optimal solution candidates are outputted, and since discrimination knowledge is actually created and since a secondary evaluated value used for evaluating the created discrimination knowledge is found, it becomes possible to create accurate, superior knowledge.

What is claimed is:

1. A knowledge forming apparatus, which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising:
a retrieving unit that retrieves a plurality of parameter sets used for calculating feature amounts;
a feature-amount operation unit that calculates a plurality of feature amounts based upon respective parameter sets that have been retrieved by the retrieving unit, in association with learning data containing given normal data and abnormal data;
a primary evaluation unit that outputs an effectiveness of respective parameter sets as an evaluated value based upon results of an operation of the feature amounts calculated by the feature-amount operation unit;
an optimal solution candidate output unit that, based upon results of a primary evaluation found by the primary evaluation unit, outputs a plurality of parameter sets having a high primary evaluated value as a plurality of optimal solution candidates;
a discrimination knowledge forming unit that forms a plurality of discrimination knowledge based upon the optimal solution candidates output from the optimal solution candidate output unit;
a secondary evaluation unit that evaluates respective discrimination knowledge that have been formed in the discrimination knowledge forming unit; and
an optimal solution output unit that, based upon the results of the secondary evaluation, outputs a discrimination knowledge having a high evaluated value as an optimal solution.

2. The knowledge forming apparatus according to claim 1, wherein the retrieving unit again retrieves respective parameter sets based upon results of evaluation in the primary evaluation unit so that effective feature amounts having a high evaluated value and the respective parameter sets of the effective feature amount are simultaneously determined.

3. The knowledge forming apparatus according to claim 1, wherein with respect to a group of feature amounts that have the same parameter or parameters in the parameter sets, the primary evaluation unit outputs a weighted sum with weights as a primary evaluated value by using weights that are set in respective feature amounts.

4. The knowledge forming apparatus according to claim 3, wherein the primary evaluation unit is capable of calculating a plurality of primary evaluated values with respect to one of the respective parameter sets, by using a plurality of patterns of weights that are set for each of the feature amounts.

5. The knowledge forming apparatus according to claim 1, wherein the primary evaluation unit is capable of calculating a plurality of primary evaluated values with respect to one of the parameter sets by using a plurality of kinds of evaluation expressions.

6. The knowledge forming apparatus according to claim 1, wherein a retrieval area specifying unit that specifies an area which is retrieved by the retrieving unit.

7. A discrimination knowledge forming method for a knowledge forming apparatus which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising the steps of:
retrieving a plurality of parameter sets that are used for calculating feature amounts;
calculating a plurality of feature amounts based upon respective parameter sets that have been retrieved, in association with learning data containing given normal data and abnormal data;
calculating a primary evaluated value indicating an effectiveness of each of the parameter sets based upon results of an operation of the feature amounts calculated by the feature-amount operation unit;
based upon the primary evaluated value, again retrieving the respective parameter sets to repeatedly execute calculations of the feature amounts and calculations of evaluated values based upon the respective parameter sets that have been retrieved;
based upon primary evaluated values upon satisfying retrieving completion conditions that have been set, determining a plurality of parameter sets as a plurality of optimal solution candidates,
based upon the optimal solution candidates, forming a plurality of discrimination knowledge; and
executing a secondary evaluation for each of the plurality of discrimination knowledge, based upon the results of the secondary evaluation, the discrimination knowledge having a high evaluated value is determined as an optimal solution.

8. The discrimination knowledge forming method according to claim 7, wherein, in the case when results of the secondary evaluation have failed to satisfy completion conditions, the process is again executed from the step of retrieving parameter sets.

9. The discrimination knowledge forming method according to claim 7, wherein, in a case when results of the secondary evaluation have failed to satisfy completion conditions, upon again executing the process from the step of retrieving parameter sets, parameter sets, which have been used upon forming discrimination knowledge having a high secondary evaluations, are given to a retrieving unit as at least some initial parameter sets.

10. A computer-implemented method, which is used in an inspecting and diagnosing apparatus for determining whether an object to be inspected is normal or abnormal and finds discrimination knowledge suitable for the object based upon feature-amount data obtained by carrying out a feature-amount extracting process on measured data acquired, comprising a program portion for executing the processes of:
causing a retrieving unit to retrieve a plurality of parameter sets that are used for calculating feature amounts;
allowing a feature-amount operation unit to calculate a plurality of feature amounts based upon respective parameter sets that have been set, in association with learning data containing given normal data and abnormal data;
calculating primary evaluated values indicating effectiveness of each of the parameter sets based upon results of an operation of the feature amounts calculated by the feature-amount operation unit;
based upon the primary evaluated values, again retrieving the parameter sets to repeatedly execute calculations of the feature amounts and calculations of the primary evaluated values based upon the respective parameter sets;
based upon the primary evaluated values upon satisfying retrieving completion conditions that have been set, determining a plurality of parameter sets as a plurality of optimal solution candidates so that a plurality of discrimination knowledge are formed based upon optimal solution candidates;
executing a secondary evaluation on each of the discrimination knowledge; and
based upon results of the secondary evaluation, discrimination knowledge having a high evaluated value is determined as an optimal solution.
